(19) United States
(12) Patent Application Publication
(10) Pub. No.: US 2019/0340704 A1
(43) Pub. Date: Nov. 7, 2019

(54) Personalized Multimedia Autographing System

(71) Applicants: David Harris Walters, Rockville, MD (US); David M Brooks, Crofton, MD (US)

(72) Inventors: David Harris Walters, Rockville, MD (US); David M Brooks, Crofton, MD (US)

(21) Appl. No.: 16/511,037

(22) Filed: Jul. 15, 2019

Related U.S. Application Data
(63) Continuation-in-part of application No. 15/425,264, filed on Feb. 6, 2017.
(60) Provisional application No. 62/294,341, filed on Feb. 12, 2016.

(51) Int. Cl. G06Q 50/00; H04L 12/58; H04L 29/08; G06Q 10/10

(52) U.S. Cl. CPC G06Q 50/01; H04L 51/32; G06F 3/0483; G06Q 10/1095; H04L 67/26

(57) ABSTRACT

This invention provides the end-to-end control, networking, and data management for the 1.) identification of event signings, 2.) generation of push invitations to such events, 3.) personalization of ebooks via reader-author collaboration to embed Personalized Multimedia Autographs (PMAs) into the ebook or other media, 4.) event line control allowing readers to browse the bookstore or mingle while waiting for collaboration with the author during these events, 5.) capability for the readers and author to discuss the event on social media after the readers have registered for the event enabling the author to tailor his/her comments at the vent to the readers' interests; 6.) synchronization and archival of the PMA among all of the reader's devices, 7.) integration of special services such as reserved seating as well as food and beverage that may make invitations to such events in the future very exclusive. This invention may be implemented using any one of several embodiments depending upon the retailer's business environment.

### 1 RELATED APPLICATIONS

This application is a continuation-in-part of U.S. Non-provisional application Ser. No. 15/425,264 filed Feb. 6, 2017 which claims priority to U.S. Provisional patent application No. 62/294,341, filed Feb. 10, 2016, entitled Personalized Multimedia Autographing System, both of which are incorporated herein by reference.

### 2 BACKGROUND OF INVENTION

The introduction of ebooks has thoroughly disrupted the publishing industry and forced the closing of many thousands of “bricks and mortar” bookstores. It has provided phenomenal benefits to readers including: a) more comfortable reading experience using a small tablet sized device with a very sharp, controllable sized font rather than a large, bulky, heavy hardcover book, b.) immediate on-line access to dictionaries, c.) near instant availability of ebook sample chapters, d.) on-line access to information related to the ebook on the Internet using embedded URL references and search engines, e.) elimination of the need for physical storage space for books, f.) lower cost, g.) constant reading quality over time compared to hardcover books whose pages become discolored and spines break or crack.

One disadvantage of ebooks is that the publishing industry has not yet adopted techniques for autographing ebooks by their authors even though ebooks open new opportunities for personalizing autographs. Furthermore, even current procedures for the autographing hardcover books involve readers waiting in lines—time readers could better spend browsing in the “bricks and mortar” store and perhaps making a purchase. Therefore, a comprehensive solution is needed to address the autographing ebooks and hardcover books for the modern publishing industry because existing solutions do not provide the services that readers desire.

### 3 PRIOR ART

The following is a tabulation of prior art that presently appears relevant:

U.S. Pat. No.

| | Kind | | |
|---|---|---|---|
| Pat. No. | Code | Issue Date | Patentee |
| 8,880,602 | B2 | 2014 Nov. 4 | Dougherty et al. |
| 8,898,587 | B2 | 2014 Nov. 25 | Patterson et al. |
| 6,845,361 | B1 | 2005 Jan. 18 | Dowling |
| 7,505,474 | B2 | 2009 Mar. 17 | Walter |
| 0,133,283 | A1 | 2008 Jun. 5 | Backer et al. |
| 0,047,332 | A1 | 2014 Feb. 13 | Liu et al. |
| 8,520,025 | B2 | 2013 Aug. 27 | Patterson et al. |
| 8,712,857 | B1 | 2014 Apr. 29 | Adornato et al. |
| 8,315,909 | B1 | 2012 Nov. 20 | Barker |
| 8,533,003 | B2 | 2013 Sep. 10 | Mueller et al. |
| 7,729,945 | B1 | 2010 Jun. 1 | Katz et al. |
| 9,152,629 | B1 | 2011 Feb. 21 | Waters et al. |

U.S. patent application Pub. No.

| | | | Applicant of |
|---|---|---|---|
| | Kind | Publication | Cited |
| Pub. No. | Code | Date | Document |
| 2003/0018524 | A1 | 2003 Jan. 23 | Fishman et al. |
| 2006/0136344 | A1 | 2006 Jun. 22 | Jones et al. |
| 2016/0345127 | A1 | 2016 May 20 | DeWitt et al. |
| 2009/0112680 | A1 | 2007 Oct. 25 | Dovrath et al. |
| 2016/0104229 | A1 | 2015 Dec. 17 | Craft et al. |
| 2007/0286220 | A1 | 2005 Jun. 14 | Stenning |

Foreign Patent Documents

| Foreign | Country | Kind | Publication | Appplicant or |
|---|---|---|---|---|
| Document | Code | Code | Date | Patentee |
| Number | | | | |
| EP 2913785 | EP | A1 | 2014 Feb. 27 | Oloeriu |

Other Publications and Sources
Autograph LLC, website: “www.autography.com”. Describes the features of their book signing service.
Authorgraph website: “www.authorgraph.com”. Describes the features of their book signing service.
A1ly Carter website, “The Dos and Don'ts of book signings,” copyright 2010, “https://allycarter.com/2010/05/the-dos-and-donts-of-book-signings”, pages 1-6

The ebook is rapidly replacing the printed physical book. It is much more efficient to download and carry an ebook then to produce, purchase and carry a physical book. There are still people that prefer a physical book due to limitations of the ebook. It is desired that the reader should be able to do everything with an ebook that can be done with a physical book in order to fully replace physical books and encourage ebook adoption. In particular, there is a need to be able to autograph and otherwise customize the book as part of a book signing with the author. This allows the reader to be able to interact with the author who they admire and be able to associate the customization with that interaction.

3.1 Dougherty

While Dougherty et al. describes a method to add an autograph to an ebook, it does not solve the issue of interaction and coordination between the bookstore, author and reader. It also does not address how physical book signings coexist with ebook signings which are intermixed randomly. There is a need for a control and data management system to identify, signup for an event and manage signing events.

3.2 Dovrath

Dovrath et. al. defines queueing methods that pre-establish fixed time slots for each user for a remote (not in person) event. This queueing method will waste the time of both readers and authors while reducing the number of readers that can be accommodated.

3.3 DeWitt

Dewitt et. al. methods do not work well for book signings where service has been scheduled weeks in advance at a predefined venue. It deals with finding and scheduling a service on demand.

3.4 Craft

Craft requires the user to set up a directive specifying an area of interest in order to receive push invitations. There is a need to make push invitations to the user more dynamic without requiring user input while still accounting for the user specific interest.

Craft introduces web crawlers for browsing the web to populate a database for events of interest—corresponding to user directives. He recognizes that the Web is built on HTML, but fails to recognize the specific structure that bookstores and other event signings venues use to display their events—a calendar format

3.5 Paterson

Paterson et al. describes methods to identify whitespace within an ebook and insert an autograph in an ebook, however it also does not provide a complete solution. Issues not addressed include coordination of the parties at the bookstore and sharing the customization across multiple devices.

3.6 Authograph

An existing solution on the market from Authograph is a remote (not in person) solution to sign ebooks in which the autograph is stored in a separate document. The user requests an autograph online and at a later time receives a separate document containing the autograph. It does not deal with the physical book store environment or the interaction of all of the parties. The solution does not support multimedia. No solution is provided to manage the autograph—this is left to the reader. Only certain books are supported based on inclusion on the website and the author participation.

3.7 Autography/Waters et al.

Waters defines methods of personalizing ebooks and authenticating signatures that result. It does not however address finding and scheduling ebooks signing events. It does not address queue management to minimize the time spent waiting and maximizing the number of readers that can be handled during a period of time. It does not describe methods to manage the interaction of the reader, author or bookstore personnel. Waters also does not describe any method to deal with a mixed environment of physical and ebooks at a signing event.

3.8 Dowling

Dowling describes virtual queueing solutions for a physical resource using smart phones, but does not address the specific needs of managing a queue for autographing in a book store with a mixture of physical books and ebooks or for a two-step process of author talk following by reader signings.

3.9 Walter

Walter describes methods to manage a queue using smart phones to communicate with the person in the queue. However, it does not provide methods to manage a queue for autographing books in a book store with a mixture of physical books and ebooks.

3.10 Backer

Backer et al. describes methods to manage a queue using smart phones to communicate with the person in the queue when it's their turn. Again, however, it does not provide methods to manage a queue for autographing books in a book store with a mixture of physical books and ebooks.

3.11 Stenning

Stenning queueing is specified to support the scenario where queue members are coming and going at irregular times. Therefore, the queueing algorithms used in Stenning do not meet the needs of a signing event which is a fixed time event.

3.12 Liu

Liu et al. describes methods to attach multimedia data to an ebook. However, it does not provide a method to store this data in a seamless way that can use the current infrastructure provided by ebooks sellers that does not modify the copyrighted ebook.

3.13 Patterson

While Patterson et al. teaches methods to attach video and audio to an ebook. It also does not address how this data is stored and synchronized across multiple user devices.

3.14 Ally-Carter

While Ally-Carter mentions the author speaking and the author signing at the event, it is not a technical document. It does not address virtual queues or describe a method. Rather it is more like a Miss Manners guide to event signings.

3.15 Prior Art Conclusion

Currently if the reader is interested in a book signing, he would have to search the internet to find where a book signing will occur and then show up unannounced and wait in line in some cases for hours. This is not a user-friendly way of either identifying upcoming book signing or interacting and queuing at the book store.

There is no way for an ebook reader to show up at a book signing and have the author personalize his book. The ebook market is large and demands a solution to enable book signings. Additionally, the signing event should allow for a random mix of ebook and physical books.

Existing solutions do not provide the services that customers desire. This invention addresses these needs as described below.

### 4 SUMMARY OF INVENTION

This invention using electronic means provides the reader with the capability to identify a book signing event of interest; register for the event; purchase an ebook license, hardcover book, as well as related special services or products; capture a media data object necessary to generate a Personalized Multimedia Autograph (PMA); generate a PMA for an ebook without modifying the copyrighted ebook content in a convenient, efficient, and personal manner; store the PMA in an on-line bookstore; display the PMA on demand at a location in the ebook selected by the reader; ensure that the PMA is synchronized among all of the reader's devices; and seamlessly interoperate with hardcover book signing events. A novel push capability is built into the invention to invite readers to book signing events when they are browsing an on-line bookstore. In cases when it is inconvenient for the author to participate in an in-store event signing, the remote embodiment of the invention enables the reader and author to perform these functions by collaborating over the Internet. The invention also includes a feature to initiate a social media conversation between the author and readers enabling them to discuss the book during the author's book tour.

In addition, the invention is designed to provide special services for event signings of the future. These services may include food, beverage, and memorabilia, as well as support for ticketed events, either complimentary or paid. It is envisioned that some ticketed events may become very exclusive compared to current book signing events. For example, ticketed book signings may charge premium prices, but include deluxe services such as cocktails and dinner with the author in addition to the PMA.

To implement these capabilities, this invention provides the end-to-end Control and Data Management system (C&DM System) for in-person event signings. Key features of the invention are: portability among user devices, authenticity of author signings, security to ensure only valid use by owners of ebook licenses, security to prevent spoofing by unauthorized individuals, push invitations to readers, synchronization among reader devices, use of imaging, video, and audio technology to generate the PMA, archival of personalized ebooks, and use of standard ebook formats. The C&DM for an in person signing events in this invention manages a special type of virtual queue consisting of two services, 1.) an author talk and 2.) reader and author collaboration for the creation of PMAs. One aspect of this invention that distinguishes it from the prior art on virtual queues is the use of this two step service type of queue and the techniques required to manage it.

The invention also utilizes a three person operations concept involving the reader, author, and venue representative. While the exact functional allocation may vary depending upon the embodiment, e.g., use of a “selfie stick” for capturing photos, the invention does free the author of all technical functions. This is a key aspect of our invention because our research indicates that the authors have a range of sensitivities in dealing with technology. Some authors are very capable while others want minimal or no involvement. Accommodating the sensitivities of all authors distinguishes our invention from other prior art.

This invention is intended to accommodate all of these cases in a manner that meets readers' needs and is profitable to bookstores, publishers, and authors.

### 5 BRIEF DESCRIPTION OF FIGURES

FIG. 1 depicts the System Diagram for the On Premise Embodiment during the Pre-Event phase.

FIG. 2 depicts the System Diagram for On Premise Embodiment during the Event Signing phase when readers arrive at the local bookstore to participate in the event.

FIG. 3 depicts a generic hardware block diagram for a smartphone embodiment for a 1 Reader Device.

FIG. 4 depicts a hardware block diagram for a tablet computing device embodiment for the 3 Local Control Device.

FIG. 5 depicts a generic hardware block diagram for a Cloud Server embodiment for the 3 Master Control Device and the 4 On-Line store and Vault (OLV).

FIG. 6 depicts a processing system in more detail for a Cloud Server embodiment for the 3 Master Control Device and 4 On-Line store and Vault.

FIG. 7 depicts a software block diagram for the 1 Reader Device.

FIG. 8 depicts a software block diagram for the 2 Master Control Device.

FIG. 9 depicts a software block diagram for the 3 Local Control Device.

FIG. 10 depicts a software block diagram for the 4 On-Line store and Vault.

FIG. 11 depicts collection of data for and the generation of the 211 Event Signing Database.

FIG. 12 depicts the Pre-Event phase involving database queries, ebooks or hardover purchases, and event registration activities.

FIG. 13 depicts the Registration Confirmation Message Display as shown on the 1 Reader Device

FIG. 14 depicts the OLV issueing a “push invitation” to a local signing event to the reader.

FIG. 15 depicts the Event Phase involving reader and author collaboration to capture and personalize a media data object, and then generate and store the PMA.

FIG. 16 depicts the Next Message display on the 1 Reader Device indicating the author is ready to collaborate with the reader to genrate a PMA.

FIG. 17A depicts an e-Book Page displaying a PMA Icon. This is the default view when the PMA is not displayed.

FIG. 17B depicts an ebook page displaying the PMA after tapping the icon. The PMA is hidden when the reader taps the X in the upper right corner of the PMA in this embodiment.

FIG. 18 depicts the Remote embodiment where the reader and author collaborate over the Internet. In this case, the author is co-located with the 3 Local Control Device.

### DETAILED DESCRIPTION

The objective of this invention is to provide the lifecycle Control and Data Management (CD&M) services necessary for the full collaboration of reader and author enabling the insertion of a PMA into an ebook during on-premises book signings for ebooks. It is also compatible with traditional autographing of hardcover books as well as other media embodiments described in Section 13.

The lifecycle begins with the invention using electronic means to capture the announcements of event signings and then display this information for readers; it continues through the storage, archival, and retrieval of the PMA. The geographical range of the invention supports a range of venues holding event signings for readers across the United States. Such venues are typically bookstores but may include think tanks, libraries, auditoriums, and other meeting places. For this embodiment, the “bricks and mortar” bookstore venue is used.

Rather than being a sequential series of steps, the operation of this invention involves parallel activities. At the top level, it consists of Signing Events Data Collection activity performed in parallel with many local Event Signings at various stages of progress. The Ongoing Signing Data Collection activity is a periodic activity and uses electronic means to retrieve event signing data (book title, genre, author, ISBN, data of signing, time, location, special services) from participating bookstores and other entities, enter the data into a database, format it for display, and respond to user queries to the database.

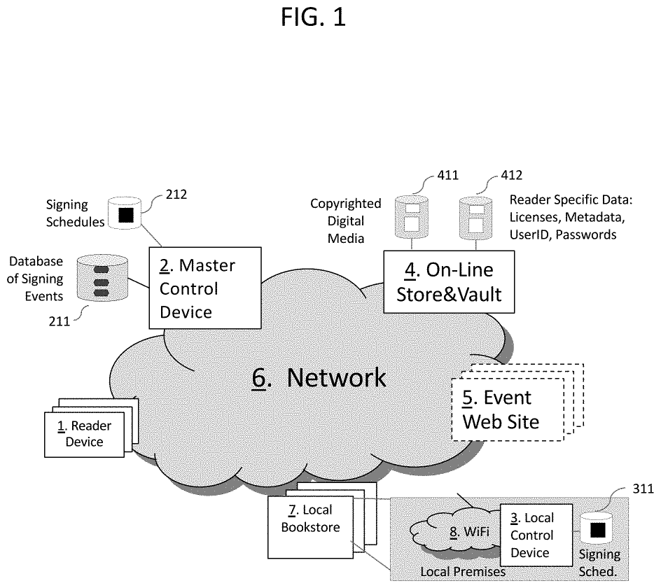

Each local Event Signing activity is organized into three phases: Pre-Event, Event, and Post-Event. FIG. 1 depicts the invention embodiment during the Pre-Event phase while the periodic Signing Events Data Collection activity is being performed in parallel. As shown in the figure, the invention system elements comprise: 1 Reader Devices, 2 Master Control Device, 3 Local Control Device resident on premises in the local bookstore conducting the signing event, 4 OLV, 5 Event Web Sites interconnected by a 6 Network, 7 Local Bookstore premises, 8 WiFi in the local bookstore.

The 5 Event Web Sites are the existing sites on the Internet used by bookstores and other entities conducting signing events to advertise these events. The 6 Network is the Internet used by consumers and businesses in the United States for commercial or personal use to perform email, file transfer, web access for such activities as social media, e-commerce, and other electronic media activities. The 8 WiFi is the IEEE 802 standard wireless local area network. The WiFi is a semi-public facility for the patrons of the venue only. The WiFi username and password are openly available for patrons, e.g. posted on signs at the venue.

Also, FIG. 1 depicts the data elements associated with this embodiment. These elements comprise: 211 Database of Signing Events and 212 Signing Schedules resident at the Master Control Device; 311 Local Signing Schedule for the 3 Local Control Device at each local bookstore; and 411 Copyrighted ebooks and 412 Reader Specific Files resident at the 4 OLV, On-line Store & Vault, including the Multimedia Notes and Highlights files storing the PMA.

The Multimedia Notes and Highlights file is an extension of traditional Notes and Highlights files to accommodate PMAs. In this invention, it is a text file of ebook metadata consisting of:

1. User Inserted Notes
Formatted text
Location for insertion of such notes into the ebook

2. User Inserted Coloring of ebook Text or Objects
Selection of color
Beginning location and end location of color into the ebook

3. PMA Insertion
Location for insertion of PMA into the ebook
Pointer to PMA file(s), i.e., the media data object with the personalized annotations.

4. Other currently supported data.

The Pre-Event phase begins when the event is entered into the database for display to the reader. The activities include:
Querying the Event Signing Database by the reader to identify events of interest,
Re-selling of ebook licenses and hardcover books,
Checking the license of ebooks to validate ownership,
Registering validated readers at Signing Events to obtain PMAs,
Integrating the registration of the signing event into the reader's personal calendar (so reminder messages will be generated),
Providing special services to readers that are event specific and may include reserved seating at Signing Events, pre-paid or complimentary food and beverage service (e.g. coffee or wine service at the event), or author memorabilia (e.g., tee shirts, engraved pen and pencil sets).

The Pre-Event phase ends and the Event Phase begins when the 3 Local Control Device begins execution of a protocol welcoming readers to the signing event by electronic means as described below.

The special services are one feature of the invention designed to attract ebook readers to “bricks and mortar” stores. These services enable the bookstore owner to offer a unique service to readers that will increase reader “traffic” into the store resulting in increased sales.

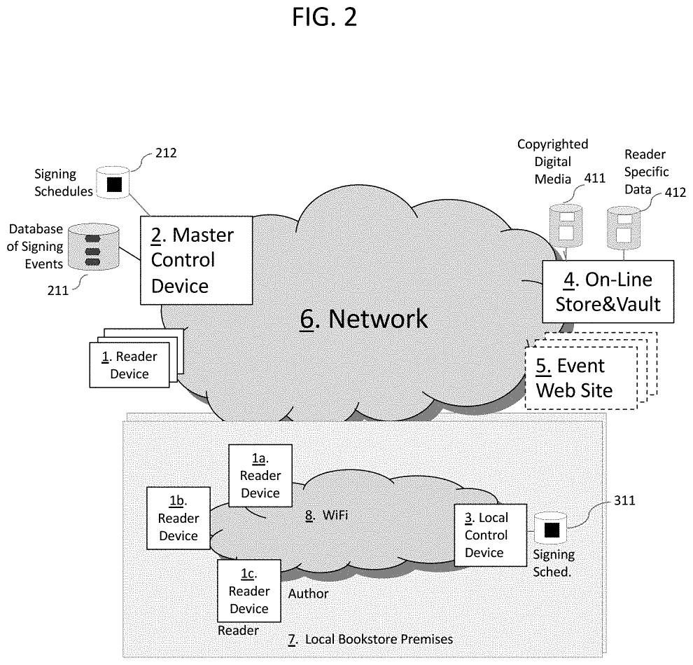

FIG. 2 depicts the Event Phase that begins when Readers (denoted by Readers 1a, lb, and 1c) have arrived at the store to meet the author and participate in the event. The activities include:
Welcoming the reader to the event by electronic means that securely verifies the identity of the reader,
Providing a special service such as reserved seating or food and beverage service,
Managing a two-step service consisting of: 1.) the author giving a talk and answering questions and 2.) the author collaborating with readers in generating PMAs,
Notifying the reader when the author is ready to sign his/her ebook by electronic means so it is unnecessary for the reader to wait in line,
Allowing the reader to select the location in the ebook where the PMA shall be inserted either by pointing or menu selection,
Capturing the PMA media data object to be used for the PMA,
Annotating the media data object by the author in a personalized manner as requested by the reader to generate the PMA,
Generating and storing the PMA in Notes and Highlights file,
Storing the PMA at the on-line book store,
Synchronizing the PMA on all of the reader's reading devices.

The invention applies to readers who own hardcover books and have smartphones, but they will obtain physical autographs rather than PMAs. However, they will have the benefits of being notified when the author is ready to sign their book and will not have to wait in line.

After the reader and author have collaborated to generate a PMA as described above, the Event Phase has been completed for that reader. The Post Event activities include:
Displaying an icon at the location in the ebook selected by the reader where the PMA is to be displayed,
Displaying the PMA on demand when the icon is actuated by tapping,
Hiding the PMA upon request by tapping a selected location of the PMA.

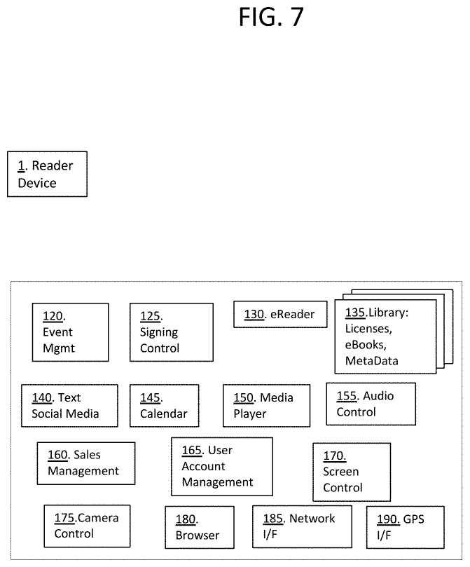

When the reader later opens the ebook associated with a particular Signing Event on another of his/her devices, the 130 eReader software component, depicted in FIG. 7, will automatically download the updated Multimedia Notes and Highlights File with the PMA from the 4 OLV. This ensures that PMA is available on all of the reader's devices.

This invention is directly applicable to ebooks that have published according to open standards, but it also applicable to ebooks that have published with Data Rights Management Protection. In the latter case, the invention would require access to the protected copyrighted material to insert the PMA.

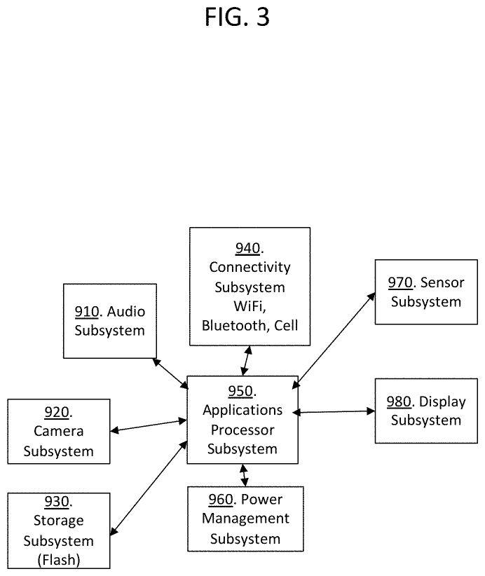

FIG. 3 depicts Smartphone hardware blocks as commonly implemented for a 1 Reader media device. The 910 audio subsystem provides functionality that includes a microphone device to capture, format and input audio and a playback system with a speaker to play audio. The 920 camera subsystem includes cameras (typically both front and rear) that allow video capture, still frame images and video conferencing. The 930 storage system allows appropriate data to be persistently stored to the device. This data includes the operating system (OS), applications (Apps), and multimedia including ebooks, and other user data. The 940 connectivity subsystem provides all connectivity to the outside world. Examples of connectivity include USB, Wi-Fi, cellular, and Bluetooth. The 950 application processor provides a processing engine to run all the code on the smart phone including the OS and Apps. The Apps include ebook readers as well as the proposed apps to allow PMAs to be implemented. The 960 power management subsystem provides hardware to charge the battery, manage heat and reduce power consumption to extend the battery life. The 970 sensor subsystem provides physical inputs to the platform that are used by the OS and apps. Examples of sensor data include GPS, compass data, orientation, light, temperature and well as finger print reader for authentication. Finally, the 980 display subsystem implements the hardware to display video and enable the touch screen. It is typically a Liquid Chrystal Display (LCD) display with touch sensing and the associated drivers. Several accessories may be used to facilitate the signing process. A commercially available “selfie stick” may be used to facilitate taking a picture with the author. Additionally, a stylus can be used to facilitate the actual inscription/autograph on the touch screen. This will provide a higher resolution than can be achieved via a finger for instance.

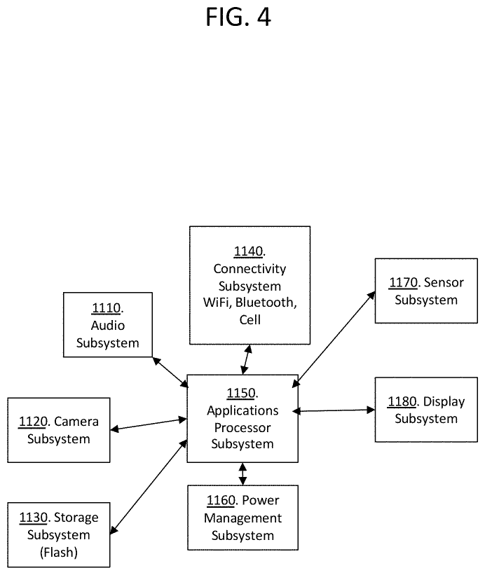

FIG. 4 depicts tablet hardware blocks. The 1110 audio subsystem provides functionality that includes a microphone device to capture, format and input audio and a playback system with a speaker to play audio. The 1120 camera subsystem includes cameras (typically both front and rear) that allow video capture, still frame images and video conferencing. The 1130 storage system allows appropriate data to be persistently stored to the device. This data includes the operating system (OS), applications (Apps), and multimedia including ebooks, and other user data. The 1140 connectivity subsystem provides all connectivity to the outside world. Examples of connectivity include USB, Wi-Fi, cellular, and Bluetooth. The 1150 application processor provides a processing engine to run all the code on the smart phone including the OS and Apps. The Apps include ebook readers as well as the proposed apps to allow PMAs to be implemented. The 1160 power management subsystem provides hardware to charge the battery, manage heat and reduce power consumption to extend the battery life. The 1170 sensor subsystem provides physical inputs to the platform that are used by the OS and apps. Examples of sensor data include GPS, compass data, orientation, light, temperature and well as finger print reader for authentication. Finally, the 1180 display subsystem implements the hardware to display video and enable the touch screen. It is typically a Liquid Chrystal Display (LCD) display with touch sensing and the associated drivers.

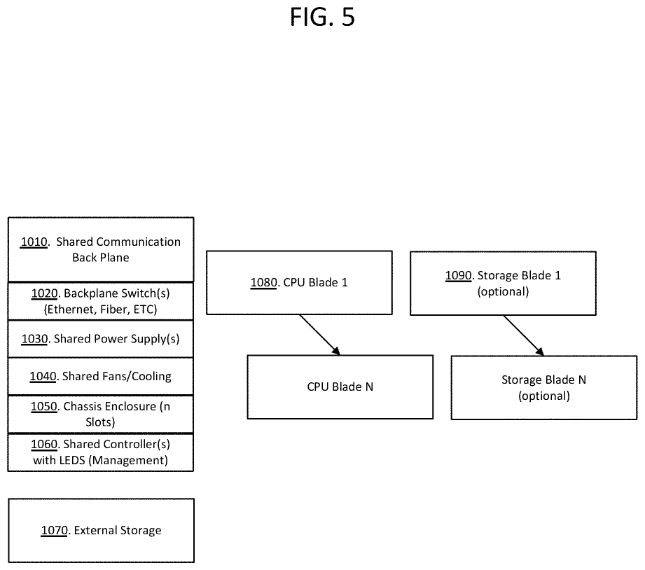

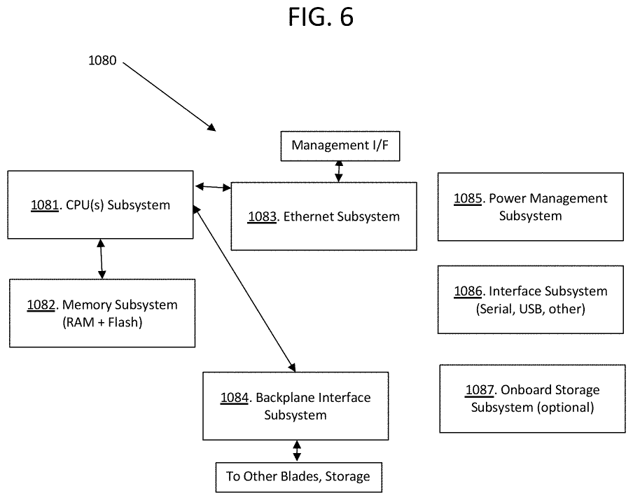

FIGS. 5 and 6 depict a typical Cloud Computing platform. These figures show one embodiment with many variations possible. The cloud platform is a large number of servers distributed geographically for redundancy and reliability. FIG. 5 shows a single server of which there are many spread across locations. The server consists of a 1010 shared backplane that is used to interconnect the 1080 server blades and optionally 1090 storage blades. A 1020 backplane switch is provided to switch data between the blades and can use Ethernet, fiber or other physical interconnects for that purpose. A 1030 shared power supply(s) provides appropriate power to the blades and other components and would be usually redundant to protect against failure. There is also a 1040 shared cooling subsystem consisting of sensors and fans to cool the server. The 1050 physical rack (chassis enclosure) provides slots to hold the blades. There is a shared controller 1060 that manages the rack and provides diagnostic information such as statistics and faults. The 1060 shared controller also provides configuration and control of the rack. The rack can hold n blades which are either 1080 CPU blades or 1090 storage blades. The 1070 external storage is used to replace or supplement the internal storage of data.

As shown in FIG. 6 each 1080 server blade is a single board computer. It is composed of a 1081 CPU subsystem which has one or more general purpose processors. The 1082 memory subsystem contains both non-volatile storage such as flash for long term storage and DRAM for temporary storage and code execution. The 1083 Ethernet subsystem provides an interface to the management subsystem as shown in FIG. 6. The 1084 backplane interface connects the blade to other blades and external devices. The 1085 power management subsystem manages the power on the blade providing the proper voltages and minimizes power consumption and manages board temperature. The 1086 interface subsystem provides other interfaces such as serial, USB, and proprietary interfaces. Finally, the 1087 onboard storage optionally provides non-volatile storage that is internal to the blade.

FIG. 7 depicts 1 Reader Device software implemented as a smartphone app comprising the invention specific app components and commercial components readily available in all smartphones. The major app software components of this invention residing in the 1 Reader Device are the 120 Event Management component to execute the pre-event and event management activities for the reader and the 125 Signing Control component to execute the reader-author collaboration activities at the signing event.

The scope of 120 Event Management activities comprise the querying of the 211 Event Signings Database in the 2 Master Control Device to identify events of interest to reader; registering for such events; interfacing with the 145 Calendar component to generate reminders; interfacing with 160 Sales Management component when the reader desires to purchase either an ebook or hardcover book; coordinating the signing schedule with the 3 Local Control Device at the Signing Event; and providing status to the 2 Master Control Device.

The scope of the 125 Signing Control activities comprises generating the PMA, selecting the location for the PMA to be inserted into the ebook, interfacing with 175 camera control for capture of the image, interfacing with 170 screen control for capture of the personalized annotation, and storing the PMA in the reader's ebook Notes and Highlights file.

The 1 Reader Device software also includes 130 ebook Reader with 135 ebook Library consisting of ebook licenses, ebooks, and ebook metadata. This software is similar to existing eReaders, but it is enhanced to read and store PMAs. Specifically, the 130 eReader component utilized in the invention retrieves the PMA from the reader's Notes and Highlights file to display the PMA in the ebook at a location of the reader's choice.

It hides the PMA, when the reader taps an X on the PMA. With this capability, the copyrighted ebook is not changed.

The 160 Sales Management software component is an e-commerce front-end enabling the reader to purchase ebooks and hardcover books via the 4 OLV and to either purchase or obtain special services directly from the local store.

The 165 User Account Management is a user account system provides traditional account management functions for reader access to the 2 Master Control Device and 4 OLV.

Other software components comprising the 1 Reader Device are readily available on all smartphones: 140 Text and Social Media, 145 Calendar, 150 Media Player, 155 Audio Control, 170 Screen Control, 175 Camera Control, 180 Browser, 185 Network Interface, and 190 GPS Interface.

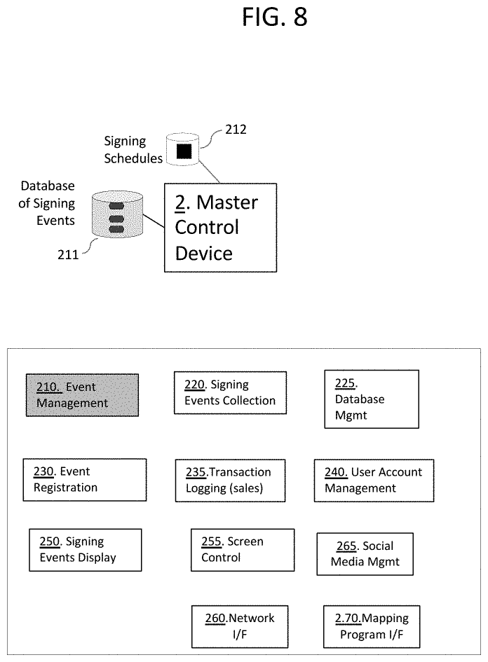

FIG. 8 depicts 2 Master Control Device software components comprising the invention components, commercial components readily available in all tablets, and data elements 211 Database of Signing Events and 212 Signing Schedules. The invention software components comprise 220 Signing Events Collection, 230 Event Registration, 235 Transaction Logging, 240. Reader Account Management, and 250 Signing Events Display. The novel invention components described whose operation are described below are the 220 Signing Events Collection and 230 Event Registration components. The 225 Database Management System component with the supporting 211 Database of Signing Events also responds to queries from the 4 OLV to match reader locations and signing events during the generation of “push invitations” to signing events. When matches are identified, the 210 Event Management component generates and transmits the “push invitations” to the 1 Reader Media Device.

Implementing a novel feature of the invention, the 265 Social Media Management component generates the handle and hash tag for insertion into the Registration Confirmation Message transmitted to the 1 Reader Media Device. These parameters identify the social media conversation between the author and readers prior to the event.

For the computation of travel times used in the “push invitation” algorithm, the 270 Mapping Program Interface accesses external mapping software to compute estimated travel times either by driving, walking, or public transportation between the reader location and an event venue.

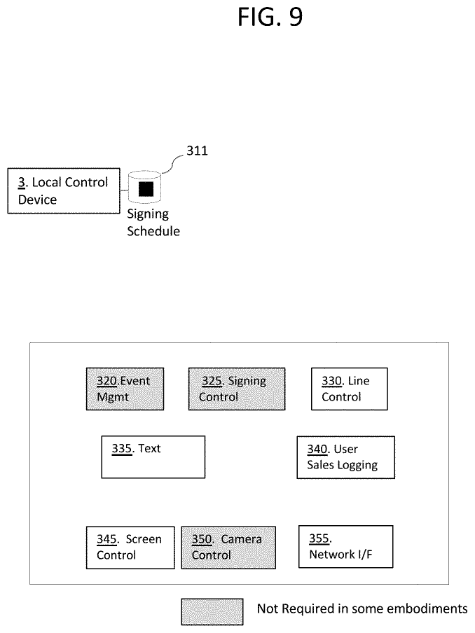

FIG. 9 depicts 3 Local Control device software components comprising the invention components, commercial components readily available in all tablets, and 311 Local Signing Schedule(s) for the local store. It maintains the signing schedule for each reader for each of its event scheduled for the local bookstore. During the event, it manages the schedule of signings. The major invention software components comprise 330 Line Control Event Management and 340 Sales Logging. It also includes commercial components 335 Text, 345 Screen Control, 350 Camera Control, and 355 Network Interface. In some embodiments the 3 Local Control Device software components may also include 320 Event Management and 325 Signing Control such as the Remote Embodiment described in Section 9. In this embodiment, the 3 Local Control Device is responsible for key functions such as line control and author-reader collaboration.

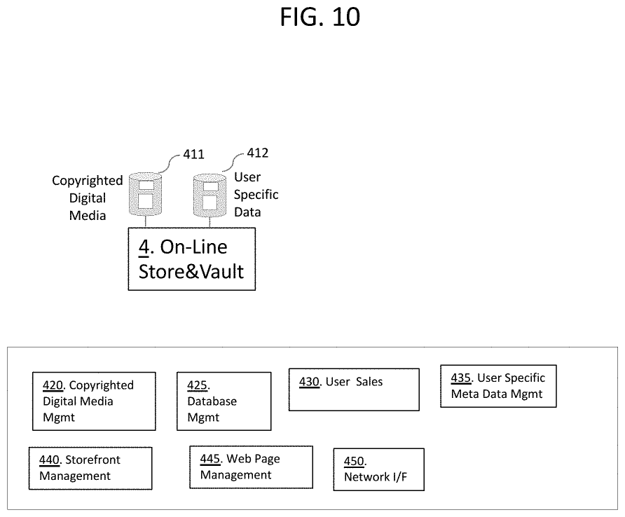

FIG. 10 depicts the 4 OLV software components comprising the invention components, commercial components, and 411 Copyrighted Digital Media and 412 Reader Specific Data. For the invention, the 4 OLV requires changes only to the 430 User Sales component to perform license validation and 440 Store Front Management for generation and transmission of “push invitations” queries, and to the 412 Reader Specific Data to accommodate the PMA in the aforementioned Multimedia Notes and Highlights file.

### 7 OPERATION

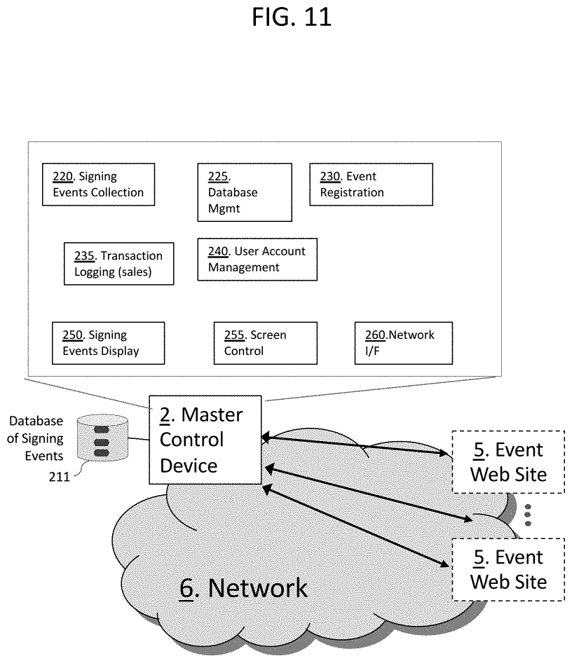

FIG. 11 depicts the periodic Event Data Collection Operation where the 2 Master Control Device queries each of the 5 Event Web sites to determine the current signing events using electronic means. This step of the invention is implemented using standard network protocols with configured URLs for the 5 Event Web Sites that display signing events.

The 220 Signing Events Collection module in 2 Master Control Device transmits a request through the 6 Network using standard protocols to retrieve the current event signing page from each 5 Event Web Site. In response, the 5 Event Web Site transmits an event file describing the current schedule of event signings to the 2 Master Control Device. It extracts the event data from the schedule stored in calendar format seven days per week twelve months per year for ease of processing.

The 220 Signings Events Collection modules in the 2 Master Control Device will parse the calendar data for each author and location, and organize it into events, and store it in the 211 Database of Signing Events; it checks for new events and updates of events already stored in the database and forwards relevant data to the 225 Database Management System module for storage in the 211 Database of Signing Events.

These data elements include but are not limited to ebook title, subtitle, ISBN, author(s), date of signing, time of signing, place of signing, address of signing, related graphic media objects, and (available) Special Services.

In parsing the received event file, the 2 Master Control Device may detect additional URLs, e.g., the full set of events could not fit one Web page. The 2 Master Control Device will repeat this process for all URLs detected in the parsing.

The 2 Master Control Device will query all 5 Event Web Sites during one update. The timing and frequency of periodic updates are configurable parameters of the invention. The parameters should be set so that the event signing data is reset on a daily basis with minimal performance impact on the performance experienced by the reader.

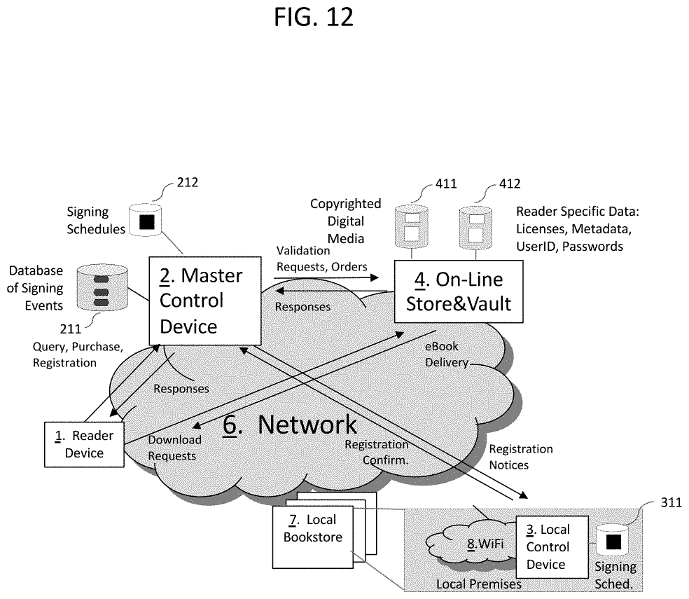

FIG. 12 depicts Pre-Event Operation beginning when the reader opens the app on his/her 1 Reader Device causing the 165 User Account Management component to securely sign in the reader automatically using the reader UserID and password and begin execution of the 120 Event Management component displaying the signing menu options. The reader then enters menu data with parameters comprising geographic area of signing locations, range of dates, and book genre(s) of interest.

After the reader enters such menu data, the 120 Event Management component in the 1 Reader Device receives the input via 170 Screen Control. The 120 Event Management component processes the inputs and transmits a request message through the 6 Network via the 185 Network Interface using standard network protocols to the 2 Master Control Device to query the 211 Event Signings Database. The 250 Signing Display component in the 2 Master Control Device receives the request and queries the 211 Signing Events Database to retrieve the relevant data and generates and formats a response message. It transmits the response through the 6 Network via the 260 Network Interface using standard protocols to the 1 Reader Device for display to the reader with options to register for the events, purchase the books in either ebook or hardcover format, and/or obtain special services. Upon identifying an event of interest, the reader registers for the event in order to obtain a PMA with or without special services. The reader may or may not purchase a book for the event because the reader may already own an ebook license. In addition, the reader may make additional queries.

If the reader has selected the option to purchase either an ebook license or hardcover book associated with the signing event and to register for a signing event, an ecommerce transaction is performed with 4 OLV via the 2 Master Control Device. In this case the 160 Sales Management component in the 1 Reader Device extracts the relevant user information from the 165 User Account component and displays the information to the reader via the 170 Screen Control component allowing the reader to edit the data. The reader enters his/her 4 OLV user account and credit information to enable the transaction, e.g. userID, social mediaID (optional), password, credit card information, or payment data. The UserID and password for the 4 OLV and 2 Master Control Device may often be configured to be the same for ease of use, but in some embodiments they may be different.

The 160 Sales Management component then executes the ecommerce transaction to purchase the book and register for the signing event by transmitting a message through the 6 Network via the 185 Network Interface using standard ecommerce protocols to the 230 Event Registration component in the 2 Master Control Device. The 230 Event Registration first performs the ecommerce transaction by extracting the purchase parameters from the message and transmitting a purchase message over the 6 Network to the 4 OLV.

The 430 User Sales component in the 4 OLV executes the transaction by authenticating the reader UserID-password, approving payment, and checking the order for any errors. Inventory would be checked for hardcover orders. It then replies to the 2 Master Control Device with its approval for the purchase and for the ebook provides a URL enabling the reader to retrieve the ebook via the 6 Network. The 2 Master Control Device forwards the response to the 1 Reader Device over the 6 Network. The 235 Transaction Logging component in the 2 Master Control Device logs the transaction.

Then the 230 Event Registration component proceeds with the signing event registration. It generates an event registration message and transmits it through the 6 Network to the 330 Line Control component in the 3 Local Control Device. This message includes the reader name, userID, security parameters (public encryption key of 1 Reader Device), and event parameters (author name, book title, date, time).

The 3 Local Control Device stores the registration in the 311 (Local) Signing Schedule file and confirms the registration by transmitting a registration confirmation message to the 230 Event Registration component in the Master Control Device. This message provides the reader with a registration confirmation number, social media identifiers (e.g., Twitter name, hashtag) for the event, and other event or facility information (Name, Address, GPS co-ordinates of the bookstore, security parameters (public key) of 3 Local Control Device).

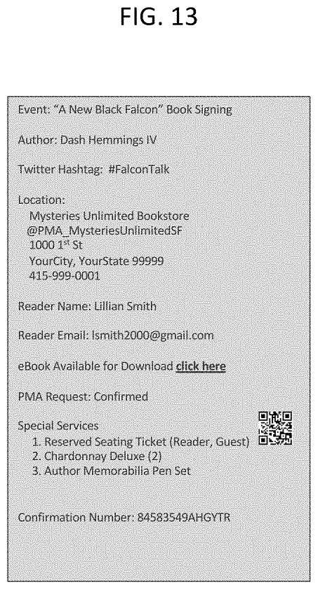

The 2 Master Control Device stores the registration in 212 Signing Schedule database. The 230 Event Registration component then transmits a Registration Confirmation message via electronic means, shown in FIG. 13, to the 120 Event Management component in the 1 Reader Device. The Registration Confirmation message includes ebook title, author, date, time, social media identifiers (e.g., Twitter name, hashtag), reader name, reader UserID, link to download the ebook (if purchased), confirmation of special services (if ordered), venue name, address, GPS co-ordinates, security parameters (public key of 3 Local Control Device, venue WiFi access parameters), and registration confirmation number. The venue WiFi access parameters may be encrypted with Reader Public Key. It may also include a validation mechanism such as a QR code.

Note after receiving the Registration Confirmation message, readers and the author may discuss the ebook and the event on social media such as Twitter. This is a very powerful capability because it enables readers to submit questions and comments to the author prior to the event. After reviewing this input, the author can tailor his/her comments at the event to the interests of the readers in attendance. Furthermore, the author may even take questions via social media during a question session at the event. The Registration Confirmation Message is the catalyst to initiate the social media conversation between the author and the readers. In some cases the author may be well known to the readers. However, in many cases, the event may be introducing readers to new authors. Therefore, the catalyst is essential to initiate the social media conversation.

What distinguishes this social media conversation versus other event based social media conversations is that this conversation proceeds as the author continues his/her book tour from city to city. It is a tour-based conversation and evolves as the author speaks to different audiences.

The 120 Event Management component adds the event to the reader's personal 145 Calendar for generation of reminder notices to the reader. The app also sets a timer to wake up the 120 Event Management component on the day of the event to check for arrival at the local bookstore and begin execution of the Arrival-Welcome protocol. This timer is set a configurable number of minutes before the scheduled time of the event.

If the reader has selected any Special Services, e.g., reserved seating, complimentary coffee, parameters for these services are included in the registration confirmation message. If the special services require pre-payment such as food and beverage, an e-commerce transaction is performed to select the item and execute the electronic transaction and then such parameters are included in the message.

For ebook purchases, the reader downloads the ebook directly from the 4 OLV to the 1 Reader Device as one would normally do for a traditional ebook purchase. Hardcover books are shipped through normal delivery means or picked up at the bookstore when getting the PMA.

If the reader only selects a signing event of interest to attend and obtain a PMA (no ebook purchase), the reader selects the Register option on the 1 Reader Device display. This requires validation of the reader's ebook license.

For Signing Event Registration, the 120 Event Management component processes and forms an Event Registration message from Account Information and Event Announcement and transmits the message through the 6 Network via the 185 Network Interface using standard protocols to the 230 Event Registration in the 2 Master Control Device. Upon receipt at the 2 Master Control Device, the 230 Event Registration component checks whether the ebook license must be validated. Since the reader has not selected the purchase option in this case, the 230 Event Registration component will continue with ebook license validation by transmitting a license validation request message through the 6 Network via the 185 Network Interface using standard protocols to the 4 OLV. The 430 User Sales component in the 4 OLV validates that the reader holds a valid license of the ebook and responds with a message to the 230 Event Registration component indicating that the reader holds a valid license.

After the ebook license has been validated, the 230 Event Registration continues with Event registration as described above. The reader may repeat these actions for additional signing events.

After having registered for a signing event, the reader may select the location for insertion and identifying icon for the PMA during either in the Pre-Event phase or the Event phase by opening the app on the smartphone and selecting the insert PMA menu option. The 125 Signing Control component via 170 Screen Control provides the reader options to either provide textual input page number, x-y co-ordinates (start: upper left, end: lower left) or to open the ebook using the 130 Reader component and point to the desired insertion location. The 125 Signing Control stores the requested insertion location (and size) where the PMA will be inserted after the reader and author collaborate to generate the PMA.

The 125 Signing Control component via 170 Screen Control provides the reader options to select the available icons by menu display or to import a graphic image that may be used as the icon. After the reader makes a selection, the 125 Signing Control component stores the requested selection.

In some cases, the reader may not find any signings in the local area. In these cases, the reader may order a signed hardcopy from a non-local bookstore and have it shipped. The purchase and registration functions as describes above; a bookstore rep will serve as a proxy to obtain the author signature. The reader may have the signed copy shipped to a home address or to a local address or to a local bookstore (to obtain free shipping and increase traffic to the store).

After the reader has completed registration for an event, the reader may use social media to engage the author and other readers who will be attending the event. After receiving the Registration Confirmation message, the 140 Text Social Media component in 1 Reader Device is configured to receive text messages based on the 2 Master Control Device social media name for the event sponsor and the event identifier (hashtag).

Readers and the author can review and respond engaging in a conversation about the event. Also, the author can tailor his/her comments at the event to the interests of the readers gleaned during the conversation. This conversation continues as the author continues his/her book tour from city to city.

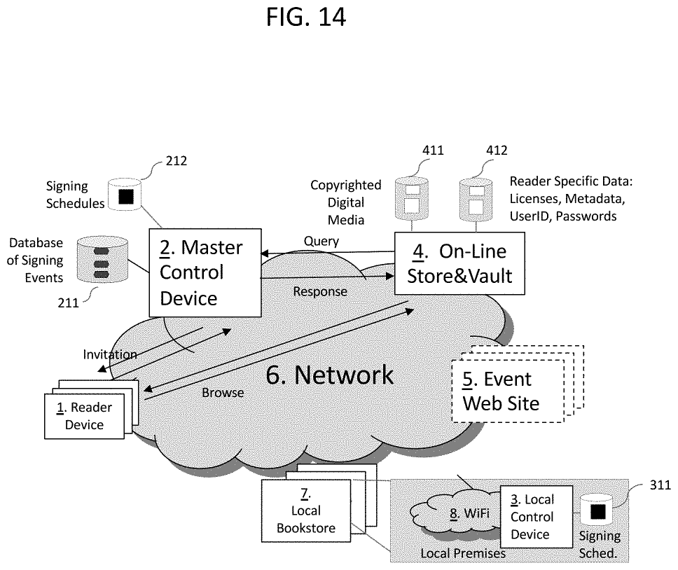

FIG. 14 depicts a reader browsing in the 4 OLV using the web browser in his/her 1 Reader Device to identify books of interest. In this case the reader identifies a book of interest and clicks on it. If the reader is signed into the 4 OLV, the 4 OLV may be able to determine the reader location from the reader profile.

The 440 Storefront Management component in the 4 OLV performs checks to determine if the book is a candidate for a book signing based on genre and publication date. For example, books signings are often held for new novels biographies, and current affairs books, but seldom held for new text and reference books. Also, the 440 Storefront Management identifies other related candidate books for signings based on the author, book genre, and publication. For example, if the reader has clicked on an espionage book by author David Ignatius, the reader may also be interested in an espionage book by author Daniel Silva. Therefore, if there are recent books by both, they are both candidates for event signings.

When the 440 Storefront Management identifies candidates for event signings, it sends a query to the 210 Event Management component in the 2 Master Control Device to determine if there are event signings convenient to the reader. The 210 Event Management component will query the 225 Database Management component to check for such events. As a first order of convenience, the 210 Event Management Component checks for events in matching Zip Codes. It then further refines the search using travel time, a configurable parameter, of the reader's location for book identified by the invention algorithm. Travel distance, may be measured by walking, driving, or public transportation travel time, is computed by accessing external mapping software using the 270 Mapping Software Interface.

If there are any such signings meeting the convenience criteria, the 2 Master Control Device will send a “Push Invitation” message to the 120 Event Management component in the 1 Reader Media Device inviting the reader to these event signings.

If the reader is interested in any of these Event Signings offered in the Push Invitations, the reader will invoke the registration process for event signings as described above.

Since the reader may use smartphones, tablets, portable PCs, or desktop PCs to make reservations, whenever the application is opened on the 120 Event Management checks with the 2 Master Control Device to download and synchronize any reservations that may have been made on any other devices.

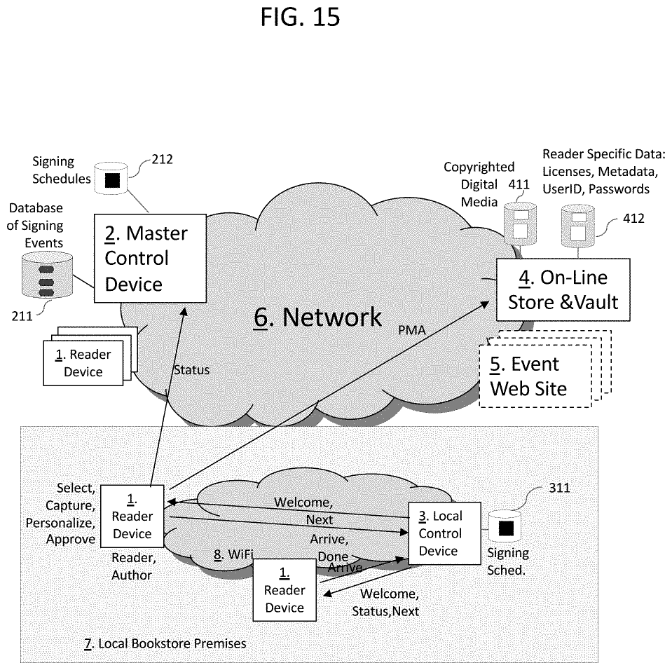

FIG. 15 depicts Reader-Author Collaboration beginning when the readers arrive at the premises of the local premises. As noted above, a timer is set to open the 120 Event Management component a configurable number of minutes before the event. The 120 Event Management component accesses 190 GPS Interface of the 1 Reader device to determine its current location and compare it with the location of the co-ordinates of the 7 Local Bookstore conducting the Signing Event. When the difference is within a configurable tolerance, the 120 Event Management component concludes that the reader has arrived at the event and begins execution of the Arrival-Welcome protocol.

The 120 Event Management component in the 1 Reader Device executes the Welcome-Arrival protocol based upon the Bookstore facilities information provided in the Registration message. It transmits an Arrival Message using this media with the Reader's Name, UserlD, Event Registration Confirmation Number, Reader Device Hardware ID, Social Media ID of the Signing Event (e.g., Twitter Name, Hashtag), and 1 Reader Device GPS Position to the 3 Local Control Device. Security parameters including the Registration Confirmation Number are encrypted using the reader private encryption key. Then the Welcome Message is encrypted using the 3 Local Control Device public key.

The 1 Reader Device knows the venue 8 WiFi Username-Password either because it has been received in the Registration Confirmation Message or has been stored from previous visits to the venue. In either case, the 1 Reader Device is able to gain access the semi-public 8 WiFi.

The 330 Line Control component in the 3 Local Control Device receives and processes this message. It decrypts the Welcome Message using its private key and decrypts the security parameters using the public key of the reader. It verifies the reader by matching the confirmation number.

It updates the 311 local schedule indicating that reader has arrived and responds with a Welcome Message. This message fixes the unique 1 Reader Device that will be used to generate the PMA.

The 330 Line Control component in 3 Local Control Device also computes and transmits the Line Control Number (LCN) in the Welcome Message to the 1 Reader Device. The LCN establishes the reader's place in queue for signing, e.g., if a reader is assigned an LCN value equal to 3, it will be the third reader to collaborate with the author in the generation of a PMA. The LCN is computed using an algorithm that is configurable based on user set parameters. The parameters may include the arrival time of the reader at the event, value of the reader's purchase for the event, value of the purchases at the store during the previous year (or some other configurable time). Purchases may include books of any media or any other purchases at the store. The 3 Local Control Device transmits the Welcome Message to the 1 Reader Media Device with security parameters encrypted with the 1 LCN private encryption key and the text of the message encrypted with the 1 Reader Media Device Public Encryption key.

The 3 Local Control Device also alerts bookstore personnel to provide any Special Services to the reader, e.g., provide a purchased hardcopy book, usher to reserved seating, or provide food and beverage service.

The Welcome-Arrival protocol described above is a message based protocol between software components of the invention in the Reader Device and the Local Control Device. It relies on a GPS sensor in the Reader Device, but it does not rely on WiFi sensing of the media access control (MAC) layer address or any other RF sensing. Thus from a networking and communications perspective, it is hardware independent.

After arriving at the bookstore, the reader will go to the “pick up central” location in the bookstore to obtain items purchased via through the special services capability. To obtain these items, the reader uses the 1 Reader Device to display the Event Signing Registration Confirmation Message for bookstore personnel. As described above, the information in this message include the reader's name, email, confirmation number, and the items purchased. The message may also include a mechanism e.g., bar or QR code, for electronic processing so that the bookstore may use electronic means rather than manual reading to validate the order.

Bookstore personnel will then provide the items, e.g., books, beverages, and food. For some more exclusive events, they may also provide tickets and usher readers to their seats.

Readers may configure their app to opt out of using the Arrival-Welcome protocol. In this case, upon arriving at the bookstore, the reader displays the Registration Confirmation message to a bookstore rep and the reader will be manually entered into the queue for a PMA and provided and special services that have been purchased.

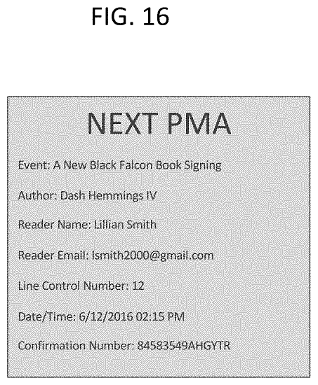

After the Step 1 has been completed where the venue representative has introduced the author and author has completed a short talk and answered some questions, Step 2 begins. To initiate Step 2 the venue representative executes a command on the 3 Local Control Device. The 330 Line Control component in the 3 Local Control Device sends messages to readers who have registered to obtain PMAs and physical autographs. The reader who is scheduled first receives a NEXT message advising the reader to meet the author in the signing area; it will also generate a NEXT message display, shown in FIG. 16, on the reader's smartphone with the event identification information, reader's name, line control number, and time stamp.

When displayed on the reader's smartphone, it also serves to verify the reader is the next person to collaborate with the author to generate a PMA—since there is one and only one person in the signing window. Thus in our invention, the NEXT message serves two purposes: advisory to alert the reader to begin collaboration and verification to ensure the author is collaborating with the scheduled reader.

The transmission time of the Next message establishes the beginning of a Signing Window during which the aforementioned unique 1 Reader Device is the only one permitted to generate a PMA with this author. The Signing Window ends when the 3 Local Control Device receives a status message receive indicating the PMA generation has been completed.

Other readers will receive Status messages indicating their relative position in the signing queue allowing them to browse in the bookstore or enjoy the available food and beverage service. When the reader's position nears the top of the queue, he/she will receive a “heads up” status message indicating collaboration with the author is imminent. When the reader's position is at the top of the queue and the author is ready to collaborate, the reader receives the NEXT message. At this time, the reader moves to the signing area to meet the author.

When the reader and author meet in the signing area, the reader uses 1 Reader Device to show the aforementioned NEXT message display to the author validating the reader for the next signing. Then the reader and the author begin collaboration. They use the 1 Reader Device to capture the media data object to be used for the PMA, in one embodiment a JPEG photograph, another an MPEG video clip. The 125 Signing Control component captures the media data object with its interface to 175 camera control. This may include attachments such as a “selfie stick” enabling the reader to easily capture a photo or video of the reader and the author. In an alternative embodiment [See Section 7 on Alternative Control Embodiments], a bookstore representative may hold the camera and capture the media object more easily depicting the reader and author.

Once the media object is captured, the reader may use the 125 Signing Control component to invoke various utilities to resize or optimize the coloring of the object. In some cases, the reader may want to take several photos or videos and pick a preferred one for use in the PMA.

After the preferred media data object has been selected, the reader and author collaborate on the personalization. The author enters the personalization inscription typically using a stylus that is captured by 125 Signing Control via 170 Screen Control and integrated with the media data object to form the PMA. It is then displayed to the reader for approval.

For a photo media data object, the author may autograph the photo with the agreed upon inscription. For a video media data object, the reader and author may collaborate to create an introductory frame that would precede the video clip when played. Its contents may comprise: title, time, date, location, names, author signature, and inscription with suitable background coloring and effects.

If the reader approves, the 125 Signing Control stores the PMA in the Multimedia Notes and Highlights file (by reference) for this ebook. It also transmits the PMA and the updated Multimedia Notes and Highlights files over the 6 Network and 8 WiFi using standard network protocols via the 185 Network Interface to the 4 OLV.

The 125 Signing Control component updates the status of PMA by transmitting a message to the 3 Local Control Device and 4 Master Control Device. The 330 Line Control component in the 3 Local Control Device invites the next reader to meet the author in the signing area by transmitting a Next message and updates the status for all other readers waiting for PMAs or hard cover autographs via Status message.

In cases where the reader does not approve of the PMA, the generation of the PMA is repeated. Several iterations are allowed where the maximum number is a configurable parameter.

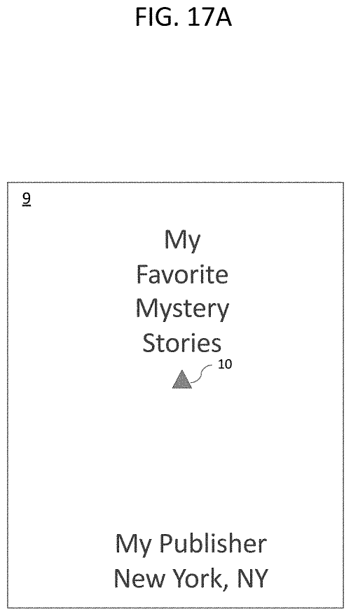

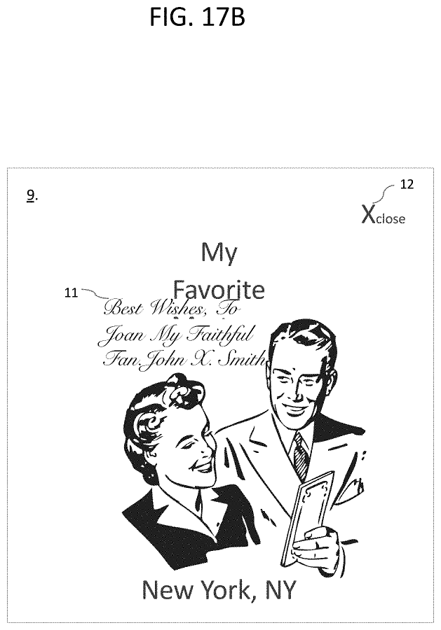

FIG. 17A and FIG. 17B depicts a sample ebook with an embedded PMA. First FIG. 17A depicts a view of an 9 ebook page using the 130 Reader software component in the 1 Reader Device after the PMA has been inserted with the 10 orange triangle icon denoting where the exact location of insertion—in this case, the location is on the title page. When the reader touches the 10 orange triangle icon, the 130 Reader component retrieves the 11 PMA, a personalized photo, from the Multimedia Notes and Highlights file and displays it to the reader via 170 Screen Control as shown in FIG. 17B.

In this example the 11 PMA overlaps some parts of textual information on the title page. When the reader touches the large 12 X, the 130 Reader component hides the 11 PMA and displays the title information and 10 orange triangle icon via 170 Screen Control. Note again, the 11 PMA is stored in the ebook Multimedia Notes and Highlights file and ebook copyrighted material is unchanged.

### 8 ALTERNATIVE READER DEVICE EMBODIMENTS

The invention may be implemented using different embodiments of the 1 Reader Device depending upon invention phase and reader preferences. For example, rather than a smartphone, the reader may use a desktop computer or a laptop computer as a 1 Reader Device to access the 211 Event Signings Database in order to identify events of interest. In this case, the 1 Reader Device (a PC) would include a Web 180 browser to access the database.

The reader could still use a smartphone to capture the PMA during the Event Phase. Alternatively, the reader could choose to use a tablet or laptop computer during the Event Phase depending upon personal preferences.

### 9 ALTERNATIVE LOCAL CONTROL DEVICE EMBODIMENTS

The invention may be implemented using different embodiments of the 3 Local Control Device depending upon invention phase and venue preferences. For example, rather than a tablet, the venue personnel may use a desktop computer or a laptop computer as a 3 Local Control Device to access the signing schedule in the 2 Master Control Device, interact with the 1 Reader Device, execute the 330 Line Control component that implements the Welcome-Arrival protocol, and execute any control commands.

### 10 ALTERNATIVE CONTROL EMBODIMENTS

In some situations, it may be more convenient for a third person (other than the reader or the author) to hold and control the device capturing the media data object. Such person may be the bookstore representative who may capture the media data object using the 3 Local Control Device.

Therefore, in this embodiment the 350 Camera Control component and 325 Signing Control component are resident in the 3 Local Control Device in order to generate and personalize the PMA.

The advantage of this embodiment is the physical ease of capturing the PMA. It provides the equivalent service of the recommended embodiment.

### 11 CLOUD EMBODIMENT

In this embodiment, the 3 Local Control Device is removed from the System Architecture. Then the Bookstore representative uses a web browser on a smartphone to a.) access the signing schedule in the 2 Master Control Device b) execute any control commands. This provides an equivalent service to the recommended embodiment.

The advantage of this embodiment is that it minimizes the data processing and storage infrastructure on the local bookstore. However, it is dependent on having network connectivity to the 2 Master Control Device.

### 12 REMOTE EMBODIMENT

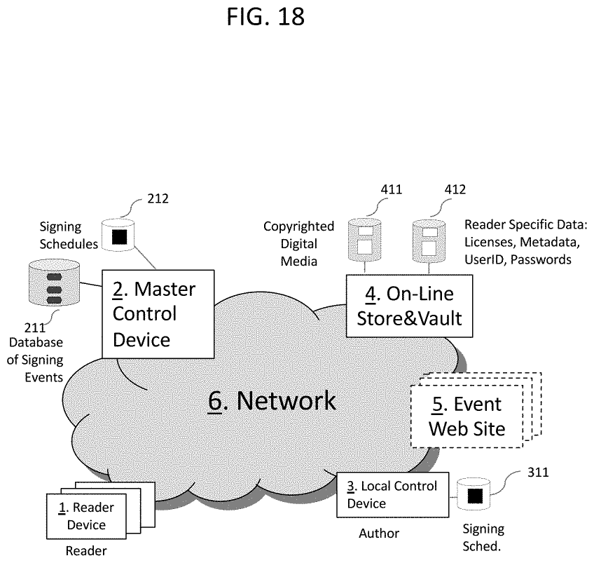

FIG. 18 depicts the Remote embodiment where it is not practical for the reader and the author to meet in order to generate a PMA. Remote signing events are included in the Signings Event database, but denoted as remote. Readers may register for them like they would register for on premise events. Readers would also select the location for the PMA and the type of icon.

When the signing window begins, the reader and author would discuss the personalization details using electronic means. The media data object could be an image or a video of the author.

As shown in the figure, the author is co-located with 3 Local Control Device that utilizes the 320 Event Management component to schedule the signings of individual readers. It also uses the 350 Camera Control component and 325 Signing Control component to generate the PMA.

Hybrid embodiments are possible. For example, the remote embodiment and the cloud embodiment could be combined with the author using only a smartphone. This is a very attractive alternative because it minimizes the software infrastructure for the author.

This embodiment is a workaround and does not provide the full functionality of the recommended embodiment because it does not capture a media data showing both the reader and the author.

### 13 NON WIFI COMMUNICATIONS EMBODIMENTS

Almost all bookstores will have WiFi networks, but some may not be so equipped. In this case network communications will be provided by texting for all messages and cellular for transmission of all media data objects.

This embodiment provides an equivalent service, but charges may be incurred and performance may be degraded.

### 14 ALTERNATIVE MEDIA EMBODIMENTS

While this description of the invention (as described in Sections 4 and 5) applies to specific photo and video data objects captured using a camera for ebooks, it can be extended to apply to other media applications including but not limited to the electronic album art of audio books, audio (MP3) and video (DVD) products.

### 15 CONCLUSIONS

This invention closes the business loop between retailers, publishers, and authors to provide a practical solution for the personalization of ebooks. It provides an end-to-end control, and data management (CD&M) solution for the identification of event signings; capability for the readers and author to discuss the event on social media after readers have registered for the event allowing the author the tailor his/her comments at the event to the readers' interest; push invitations to identify events; feature to initiate a social media conversation between the author and readers enabling them to discuss the book during the author's book tour; multimedia personalization of ebooks; line control so readers can browse the bookstore or mingle while waiting for collaboration with the author; synchronization and archival of the PMA among all of the reader's devices; special services such as reserved seating as well as food and beverage.

This invention may be implemented using any one of several embodiments depending upon the business retailer's business environment. In the basic case described in this patent application, processing and storage of scheduling data may be resident at the local bookstore. However, it is envisioned with cloud computing technology processing and storage may evolve to the cloud for many retailers. Very often a smartphone will be used as a reader device, but a laptop or tablet device may also be used for collaboration with the author during PMA generation. If it is not convenient for the reader and author to physically meet, there is a remote embodiment of the invention.

While the simplest case of this invention is the embedding of a photo into an ebook, it also covers the embedding of other media such as audio or video into an ebook. Analogously, the invention also includes the embedding of such media into cover art of audio books, DVDs and MP3 albums.

While signing events have been traditionally viewed as free and open events, the special services feature of this invention provides the framework to make signing events the exclusive, paid events of the future. For example, paid book signing events may charge premium prices, but include deluxe services such as cocktails and dinner with the author in addition to the PMA.

In summary, this invention combines a novel set of ideas not previously available to retailers, publishers, and authors providing them new and promising business opportunities.

What is claimed:

1. A computer implemented method for the Control and Data Management (C&DM) for an in person signing event consisting of two services, an author talk and reader and author collaboration for the creation PMAs (personalized multimedia autographs) scheduled on a selected date and time for a specific ebook and its author comprising the steps:
a. After a signing event has been scheduled, Server creating a virtual queue for a two step service of registered readers containing their identification, registration confirmation, service order, and security parameters for the signing event using electronic processing and communications,
b. Reader Media Device of reader registered for such signing event autonomously detecting arrival at the signing venue via satellite positioning system, and requesting event registrations by electronic communications,
c. Server confirming reader arrival, computing the reader service order in the queue, and notifying reader using electronic processing and communications,
d. Server initiating the reader-author collaboration after the author has completed an introductory talk, computing the unique Signing Window comprising start time and end time for each Reader and Author collaboration, and notifying each Reader when the Reader is next in line to collaborate with the author using electronic processing and communications,
e. Issuing Push Invitations to the reader initiated by the reader clicking on a specific book while browsing the On-Line Store and Vault (OLV) subject to checking that 1.) a signing event may be held for such ebook based on author availability, book publication date and book type and 2.) proximity of reader and event venue is within a configured travel time using electronic processing and communications,
f. Initiating a book tour social media conversation for this signing event and all events on the author's book tour using the Registration Confirmation Message.

2. A computer implemented method for the C&DM of claim 1 comprising the steps: 1.) scanning Internet Web sites of event signing venues, 2.) identifying the event data on the venue web site in calendar format specified in days, weeks, months, 3.) retrieving the event signing data including author, ebook title, location, calendar date and time, 4.) storing the data in a database and 5.) making it available for reader access using electronic processing and communications.

3. A computer implemented method for the C&DM of claim 1 comprising the steps:
a. Reader Media Device accessing the database of event signings, transmitting a registration request for a signing event containing reader identification parameter comprising UserID, password, and reader security parameter comprising reader public encryption key to a server,
b. Server 1.) receiving and processing reader registration request, 2.) transmitting a response with registration confirmation number and server security parameter comprising server public encryption key and 3.) creating registration queue of registered readers for the signing event using electronic processing and communications.

4. A computer implemented method for the C&DM of claim 1 comprising the steps:
a. Reader Media Device of a reader registered for a signing event at a signing venue at a specific data and time 1.) autonomously detecting arrival at the signing venue via satellite positioning system, 2.) encrypting reader authentication parameters comprising confirmation number in the Arrival Message using the reader private key, 3.) encrypting the Arrival Message with the Server public key, and 4.) transmitting the Arrival Message using electronic processing and communications,
b. Server 1.) receiving the Arrival Message, decrypting of the Arrival Message using the server's private encryption key, 2.) decrypting the authentication parameters using the reader public encryption key confirming the reader's arrival, and 3.) authenticating the reader's identity using electronic processing,
c. Server 1.) computing the reader Line Control Number (LCN) that determines the reader's relative author collaboration priority using an algorithm with configurable parameters that may include the arrival time of the reader at the event, value of the reader's purchase for the event, value of the purchases at the store during a configurable time period, 2.) generating a Welcome Message with the LCN, 3.) encrypting authentication parameters using the server private key, 4.) encrypting the Welcome Message using the reader public key, and 5.) transmitting the Welcome Message using electronic processing and communications.

5. A computer implemented method for the C&DM of claim 1 comprising the steps:
a. Reader Media Device 1.) receiving the Server's Welcome Message, 2.) decrypting of the Welcome Message using the reader private encryption key, 3.) decrypting the authentication parameters using the server public encryption key confirming the server identity using electronic processing and communications,
b. Reader Media Device 1.) sending status to the server when each PMA is completed using electronic communications,
c. Server 1.) initiating the reader-author collaboration after the author has completed an introductory talk, 2.) computing the unique Signing Window comprising start time and end time for each Reader and Author collaboration based on: the readers' LCNs, number of registered Readers, and estimated PMA creation time, and notifying each Reader when that Reader is next in line to collaborate with the author, 3.) generating a NEXT message notifying the reader that the reader is next in line to collaborate with the author, 4.) transmitting the NEXT message to the reader and 5.) storing the status of each collaboration using electronic processing and communications.

6. A computer implemented method for the C&DM of claim 1 comprising the steps: uniquely identifying personalized PMAs created at in person events by assigning and storing in a database the unique parameters identifying each PMA: book title, author, signing venue name and location, author, date, ebook license number and signing window start time and end time defined as the time the PMA was approved by the reader or time maximum number of attempts reached and then status updated.

7. A computer implemented method for the C&DM of claim 1 comprising the steps: creating a PMA where the author and reader collaborate using a single reader provided media device with the assistance of a venue representative and a server operating in the background transparent to both the reader and the author.

8. A computer implemented method for the C&DM of claim 1 comprising the steps: 1.) OLV performing event checks on books that a signing event may be held for book based on author availability, publication date, and type of book for books identified by the reader while browsing the OLV, 2.) identifying other related candidate books for signings based on the author, book genre, and publication, 3.) OLV notifying the server for all identified books that pass the event checks, 4.) server accessing the database of event signings and performing a configurable event venue to reader proximity check based on a computed travel time measured by driving, walking, or using public transportation between the reader location and venue, and 5.) the server issuing a push invitation to the reader for all events passing the proximity check using electronic processing and communications.

9. An electronic system for C&DM for an in person signing event consisting of two services, an author talk and reader and author collaboration for the creation of PMAs scheduled on a selected date and time for a specific ebook and its author comprising:
a. Reader Media Computing Device with 1.) an attached touchscreen for input and output including PMA display, 2.) a photo or video camera to capture a media data object, 3.) an application processor with memory for a reader registered for such signing event, autonomously detecting arrival at the signing venue via satellite positioning system, requesting event registrations by electronic communications, creating PMAs by reader-author collaboration, and updating the status of PMA creation,
b. Local Control Device with 1.) an attached touchscreen to control and manage the PMA applications, 2.) a network interface to communicate with the Reader Devices and Master Control Device, 3.) an application processor with memory executing the PMA applications that after a signing event has been scheduled, create a virtual queue for two step service of registered readers containing their identification, registration confirmation; service order, and security parameters for the signing event, confirming reader arrival; computing the reader service order in the queue, and notifying reader; initiating the reader-author collaboration after the author has completed an introductory talk; computing the unique Signing Window comprising start time and end time for each Reader and Author collaboration; notifying each Reader when that Reader is next in line to collaborate with the author, and maintaining status of the PMA creation process using electronic processing and communications;
c. Master Control Device with 1.) CPU blades with memory and database management system and 2.) a network interface to communicate with the On-Line Store and Vault (OLV) and Local Control Device constructing and storing the events signings database; constructing and storing the reader registration database; transmitting Push Invitations to the reader subject to checking a signing event may be held for such ebook based on author availability, book publication date and book type and proximity of reader and event venue is within a configured travel time; initiating a book tour social media conversation for this signing event and all events on the author's book tour using the Registration Confirmation Message; and storing status of PMA creation process of event signings using electronic processing and communications.

10. The electronic system of claim 9 wherein the Master Control Computing Server Device performs C&DM for the process of creating the PMA at in person signing events comprises: 1.) scanning Internet Web sites of event signing venues, 2.) identifying the event data on the venue web site in calendar format specified in days, weeks, months, 3.) retrieving the event signing data including author, ebook title, location, calendar date and time, 4.) storing the data in a database and 5.) making it available for reader access using electronic processing and communications.

11. The electronic system for the C&DM of claim 9 that performs C&DM for the process of creating the PMA at in person signing events wherein:
a. Reader Media Device performing C&DM comprises accessing the database of event signings, transmitting a registration request for a signing event containing reader identification parameter comprising UserID, password, and reader security parameter comprising reader public encryption key to a server,
b. Master Control Computing Server Device performing C&DM comprises 1.) receiving and processing reader registration request, 2.) transmitting a response with registration confirmation number and Local Control Device security parameter comprising the Local Control Device's public encryption key to the Reader Device,
c. Local Control Computing Server Device performing C&DM comprises creating registration queue of registered readers for the signing event using electronic processing and communications.

12. The electronic system of claim 9 performs C&DM for the process of creating the PMA at in person signing events wherein:
a. Reader Media Device performing CD&M comprises 1.) autonomously detecting arrival at the signing venue via satellite positioning system, 2.) encrypting reader authentication parameters comprising registration confirmation number in the Arrival Message using the Reader Device private key, 3.) encrypting the Arrival Message with the Local Control Device public key, and 4.) transmitting the Arrival Message using electronic processing and communications,
b. Local Control Computing Server Device performing C&DM comprises 1.) receiving the Arrival Message, 2.) decrypting of the Arrival Message using the server's private encryption key and 3.) decrypting the authentication parameters using the reader public encryption key confirming the reader's arrival,
c. Local Control Computing Server Device performing C&DM comprises 1.) computing the reader Line Control Number (LCN) that determines the reader's relative author collaboration priority using an algorithm with configurable parameters that may include the arrival time of the reader at the event, value of the reader's purchase for the event, value of the purchases at the store during a configurable time period, 2.) generating a Welcome Message with the LCN, 3.) encrypting authentication parameters using the server private key, 4.) encrypting the Welcome Message using the Reader Device public key, and 5.) transmitting the Welcome Message using electronic processing and communications.

13. The electronic system of claim 9 performs C&DM for the process of creating the PMA at in person signing events wherein:
a. Reader Media Device performing C&DM comprises 1.) receiving the Local Control Device Welcome Message, 2.) decrypting of the Welcome Message using the Reader Device private encryption key and 3.) decrypting the authentication parameters using the Local Control Device public encryption key confirming the Local Control Device identity using electronic processing and communications,
b. Reader Media Device performing C&DM comprises sending status to the Local Control Device when each PMA is completed using electronic communications,
c. Local Control Computing Server Device performing C&DM comprises 1.) initiating the reader-author collaboration after the author has completed an introductory talk, 2.) computing the unique Signing Window comprising start time and end time for each Reader and Author collaboration based on: the reader's LCNs, number of registered Readers, and estimated PMA creation time, and notifying each Reader when that the Reader is next in line to collaborate with the author, 3.) generating a NEXT message notifying the reader that the reader is next in line to collaborate with the author, 4.) transmitting the NEXT message to the reader and 5.) storing the status of each collaboration 6.) transmitting a status message to the Master Control Device that stores the status of all collaborations using electronic processing and communications.

14. The electronic system of claim 9 performs PMA C&DM during ebook signing events by uniquely identifying personalized PMAs created at in person events by assigning and storing in a database the unique parameters identifying each PMA: book title, author, signing venue name and location, author, date, ebook license number, signing window start time and end time defined as the time the PMA was approved by the reader or time maximum number of attempts reached and then status updated.

15. The electronic system of claim 9 for C&DM for an in person signing event performs PMA C&DM during ebook signing events by creating a PMA where the author and reader collaborate using a single reader provided media device with the assistance of a venue representative and the Local and Master Control Devices operate in the background transparent to both the reader and the author.

16. The electronic system of claim 9 comprising: 1.) OLV performing event checks on books that a signing event may be held for book based on author availability, publication date, and type of book for books identified by the reader while browsing the OLV, 2.) OLV identifying other related candidate books for signings based on the author, book genre, and publication date, 3.) OLV notifying the Master Control Device for all identified books that pass the event checks, 4.) Master Control Device accessing the database of event signings and performing a configurable event venue and reader proximity check based on a computed travel time measured by driving, walking, or using public transportation between the reader location and venue and 5.) the Master Control Device issuing a push invitation to the Reader Media Device for all events passing the proximity check using electronic processing and communications.

17. A computer implemented method for the C&DM of claim 1 comprising the steps: a) specifying a social media handle and hashtag to initiate a social media conversation on the signing event and all events on the author's tour regarding the book, b.) inserting the social media handle and hashtag into the Registration Confirmation Message transmitted by the Server to the Reader.

18. The electronic system of claim 9 comprising the steps: a) specifying a social media handle and hashtag to initiate a social media conversation on the signing event and all events on the author's tour regarding the book, b.) Master Control Device inserting the social media handle and hashtag into the Registration Confirmation Message transmitted to the Reader Device.
